(19) United States
(12) Patent Application Publication
(10) Pub. No.: US 2009/0116261 A1
(43) Pub. Date: May 7, 2009

(54) Side-emitting backlight module

(75) Inventors: Chien-Hsiang Chen, Hsinchu (TW); Ming-Dah Liu, Hsinchu (TW)

Correspondence Address: BACON & THOMAS, PLLC, 625 SLATERS LANE, FOURTH FLOOR, ALEXANDRIA, VA, 22314-1176, US

(73) Assignee: Nano Precision Corporation, Hsinchu (TW)

(21) Appl. No.: 12/213,314

(22) Filed: Jun. 18, 2008

(30) Foreign Application Priority Data
Nov. 7, 2007 (TW) 096141967

(51) Int. Cl. F21V 7/04

(52) U.S. Cl. 362/609; 362/612

(57) ABSTRACT

A side-emitting backlight module includes a light guide plate and a plurality of point light sources. The light guide plate has a light incident end face. The point light sources are arranged as a first row and a second row. Each of the point light sources has a light emitting face. The first row is disposed between the second row and the light guide plate. Each point light source of the first row is staggered with respect to each point light source of the second row, so that each light emitting face of the point light sources fronts the light incident end face of the light guide plate.

### BACKGROUND OF THE INVENTION

(1) Field of the Invention

The present invention relates to a side-emitting backlight module, particular to a side-emitting backlight module having point light sources.

(2) Description of the Prior Art

Notebook computer requires lightness and thinness, whose back light source adopts the side-emitting backlight module. To save energy, the side-emitting backlight module uses point light source, such as white light emitting diode (LED) as its light emitting element. Therefore, there is spotty halo generated near the edge of the panel in the notebook computer because the edge is near the light emitting element, which means it will be brighter and whiter near the LED.

FIG. 1 shows a conventional side-emitting backlight module 100 and the spotty halo phenomenon. The side-emitting backlight module 100 comprises a light guide plate 120 and a plurality of LEDs 140. The LEDs 140 are disposed beside the light guide plate 120. Because each of the LEDs 140 is a point light source, considering the optical efficiency, the light guide plate 120 is just a little thicker than each of the LEDs 140 to reach the requirement of lightness and thinness. However, there is space between two adjacent LEDs 140 to place circuit (not shown) or the LED fixture (not show), so that the brightness distributes unevenly and spotty halo appears just as the bright zone 160 shows in FIG. 1.

The problem can be solved by adjusting the LED distribution. For example, increasing the number of the LED to decrease the space or selecting the LED with larger light emitting angle to reduce the bright zones and improve the uneven brightness, but the heat source will increase when adding the number of the LED.

Meanwhile, the assembly error will remove the position of the LED easily, so adjusting the position of the LED needs correcting of mold for many times, which increases the cost indirectly.

### SUMMARY OF THE INVENTION

The invention is to provide a side-emitting backlight module, which may improve the spotty halo phenomenon, and increase the color gamut and the heat dissipation area.

For one or part of or all objectives mentioned or other objectives, one embodiment of the present invention provides a side-emitting backlight module which includes a light guide plate and a plurality of point light sources. The light guide plate has a light incident end face. The point light sources is arranged as a first row and a second row. Each the point light source of the first row and the second row has a light emitting face. The first row is disposed between the second row and the light guide plate. Each the point light source of the first row is staggered with respect to each the point light source of the second row, so that a part of the light emitting face of each the point light source faces the light incident end face of the light guide plate.

Another embodiment of the present invention provides a side-emitting backlight module, which includes a light guide plate, a plurality of first point light sources, a plurality of second point light source. The light guide plate has a first light incident end face and a second light incident end face at two sides of the light guide plate separately. The plurality of first point light sources are arranged as a first row and a second row. Each of the first point light sources of the first row and the second row has a first light emitting face, and the first row is disposed between the second row and the light guide plate. Each of the first point light sources of the first row is staggered with respect to each of the first point light sources of the second row, so that a part of the first light emitting face of the first point light sources faces the first light incident end face of the light guide plate. The plurality of second point light sources are arranged as a third row and a forth row. Each of the second point light sources of the third row and the forth row has a second light emitting face, and the third row is disposed between the forth row and the light guide plate. Each of the second point light sources of the third row is staggered with respect to each of the second point light sources of the forth row, so that a part of the second light emitting face of the second point light sources faces the second light incident end face of the light guide plate.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which

FIG. 1 is the schematic view of the conventional side-emitting backlight module and its spotty halo phenomenon;

FIG. 2 is the schematic view showing a first embodiment of the side-emitting backlight module according to the present invention.

FIG. 3 is the side schematic view showing the first embodiment of the side-emitting backlight module according to the present invention;

FIGS. 4A and 4B are the stereo view showing the LED arrangement in the first embodiment according to the present invention;

FIG. 5 is the schematic view showing a second embodiment of the side-emitting backlight module according to the present invention;

FIG. 6 is the side schematic view showing the second embodiment of the side-emitting backlight module according to the present invention;

FIG. 7 is the schematic view showing a third embodiment of the side-emitting backlight module according to the present invention; and

FIG. 8 is the schematic view showing a forth embodiment of the backlight module with four-side light incident according to the present invention.

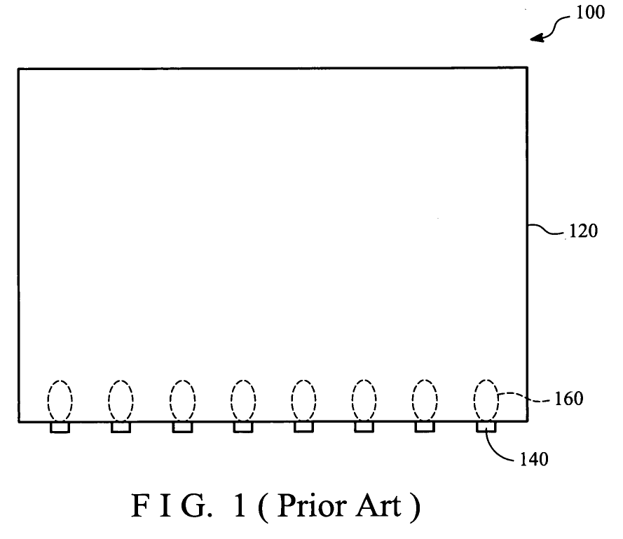

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

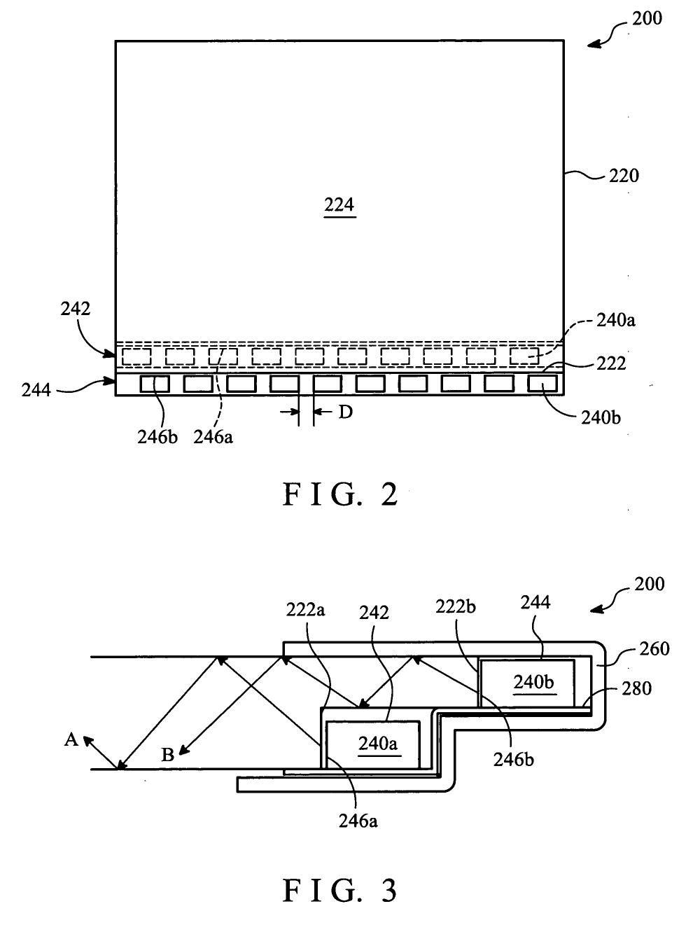

Referring to FIG. 2, a side-emitting backlight module 200 includes a light guide plate 220 and a plurality of LEDs. The light guide plate 220 has a light incident end face 222. The LEDs are arranged as the first row 242 and the second row 244. For convenient explanation, the LED of the first row 242 is marked 240a and the LED of the second row 244 is marked 240b. Each LED 240a and 240b has a light emitting face 246a and 246b respectively. The first row 242 is disposed between the second row 244 and the light guide plate 220. Each the LED 240a of the first row 242 is staggered with respect to the LED 240b of the second row 244, so that each the light emitting face 246a and 246b may front the light incident end face 222 of the light guide plate 220. Noticeably, the space between the two adjacent LED 240a of the first row 242 will lead to uneven brightness distribution, which can be improved by the staggered arrangement of the LED 240a and 240b.

FIG. 3 is the side schematic view of the side-emitting backlight module 200. Preferably, the first row 242 and the second row 244 are arranged in a ladder shape and the second row 244 is located higher than the first row 242. Thereby, the light emitting face 246b of the LED 240b in upper row will not be covered by the circuit between the two adjacent LED 240a in the lower row and can front the light incident end face 222b of the light guide plate 220 more effectively. It is better for the shorter distance between the light incident end face 222 of the light guide plate 220 and the LED 240a,240b. The light incident end face 222 of the light guide plate 220 is made in a ladder shape to match the LED 240a, 240b arranged in ladder.

As the FIG. 3 shows, the light incident end face 222 has two steps, including the first end face 222a and the second end face 222b with different height. The location of the first row 242 is near a visible area 224 of the light guide plate 220, so it is better to use white LED for the LED 240a of the first row 242. The location of a second row 244 is far from the visible area 224 of the light guide plate 220, so it has better light mixing effect due to the long light mixing distance. The second row 244 can also use red, blue and green LED besides white LED. Each the LED 240b can contain not only a single color chip inside, but also red, blue and green chips at the same time, so that the color field of the side-emitting light module can be increased by the light mixing effect.

FIG. 3 also shows the side-emitting backlight module 200 further including a ladder-shaped reflector 260 and a flexible circuit board 280. The ladder-shaped reflector 260 covers the LED 240a,240b and has two stepped parts, respectively corresponding to a back side of each the LED 240a in the first row 242 and a back side of each the LED 240b in the second row 244.The back sides of each LED 240a and 240b are opposite to their light emitting face 246a and 246b. The flexible circuit board 280 is electrically connected to the LED 240a and 240b and disposed between a ladder-shaped reflector 260 and the LED 240a, 240b.

FIG. 3 also shows a light guide path. The light from the LED 240a of the first row 242 goes along the path A, while the light from the LED 240b of the second row 244 goes along the path B.

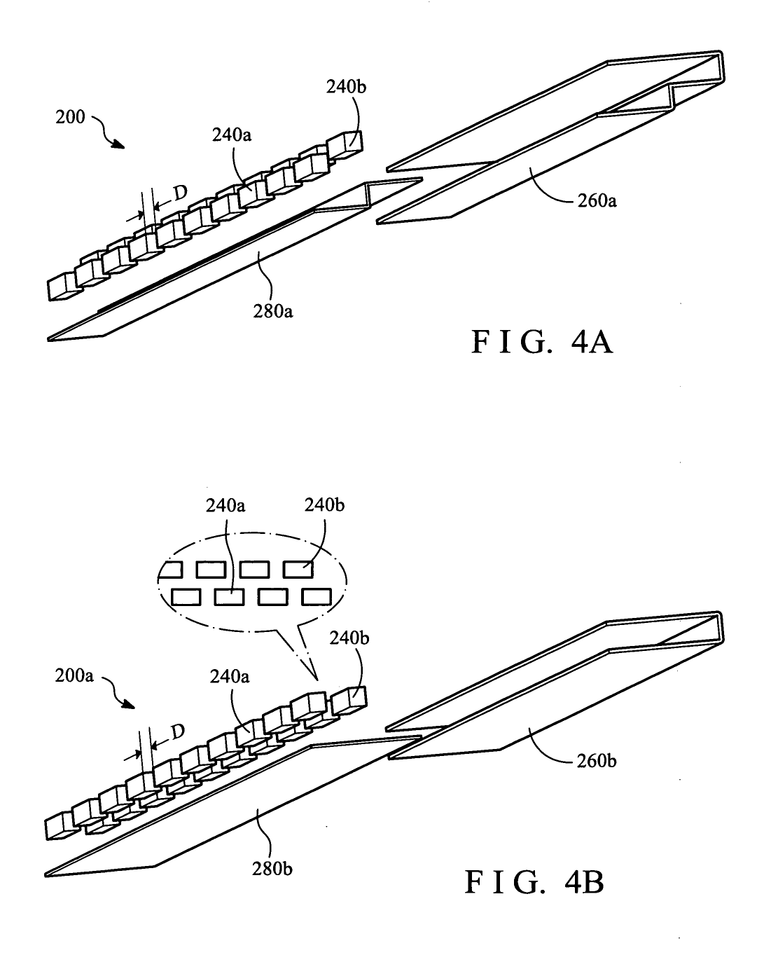

FIG. 4A shows the stereo view of the LED 240a,240b arrangement applied in the side-emitting backlight module 200. Referring to FIG. 2 also, there is space D between the two adjacent LED 240a,240b of the same row 242,244 to place circuit(not shown) or to fix the relevant LED 240a,240b. Each the LED 240b of the second row 244 is disposed at the back of the space D between the two adjacent LED 240a of the first row 242. Each the LED 240a of the first row 242 is staggered with respect to each the LED 240b of the second row 244. The types of the corresponding reflector 260a and a flexible circuit board 280a are as the FIG. 4A shows.

FIG. 4B shows the stereo view of the LED 240a,240b arrangement applied in another side-emitting backlight module 200a. The part in broken line is the top schematic view. The LED 240a, 240b of the side-emitting backlight module 200a are staggered at the same plane, not limited to the above-mentioned ladder shape arrangement. The types of the corresponding reflector 260b and the flexible circuit board 280b are as the FIG. 4B shows.

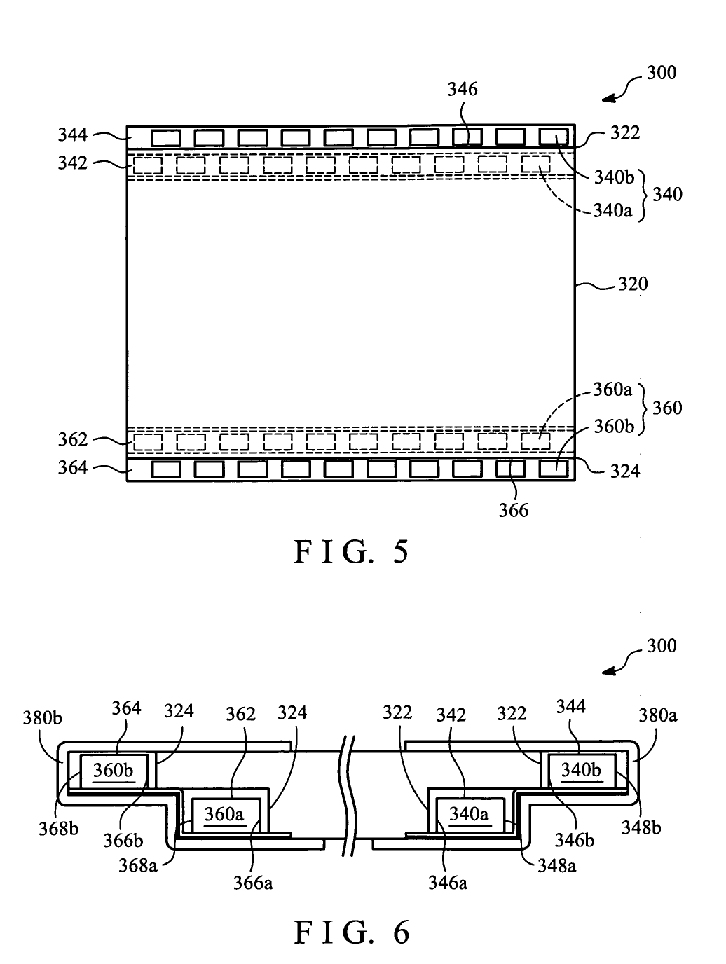

Referring to FIG. 5 and FIG. 6, a side-emitting backlight module 300 comprises a light guide plate 320 which includes a first light incident end face 322 and a second light incident end face 324 located at the two opposite sides of the light guide plate 320.

A plurality of first LEDs 340 are disposed as a first row 342 and a second row 344. For convenience, the first LED of the first row 342 is marked 340a and the first LED of the second row 344 is marked 340b. Each the first LED 340 has a first light emitting face 346. The first row 342 is disposed between the second row 344 and the light guide plate 320. Each the first LED 340a of the first row 342 is staggered with respect to each the first LED 340b of the second row 344, so that each the first light emitting face 346 may front the first light incident end face 322 of the light guide plate 320.

A plurality of second LEDs 360 are disposed as a third row 362 and a forth row 364. For convenience, the second LED of the third row 362 is marked 360a and the second LED of the forth row 364 is marked 360b. Each the second LED 360 has a second light emitting face 366. The third row 362 is disposed between the forth row 364 and the light guide plate 320. Each the second LED 360a of the third row 362 is staggered with respect to each the second LED 360b of the forth row 364, so that each second light emitting face 366 may front the second light incident end face 324 of the light guide plate 320.

Noticeably, there are space between the two adjacent first LED 340a of the first row 342 and between the two adjacent second LED 360a of the third row 362, which make brightness distribution uneven. The uneven brightness distribution can be improved by the staggered arrangements of the LED 340a and 340b or the LED 360a and 360b.

Refer to FIG. 6 for the side schematic view of the side-emitting backlight module 300. Preferably, the first row 342 and the second row 344 are arranged in a ladder shape, and the second row 344 is located higher than the first row 342. The third row 362 and the forth row 364 are arranged in a ladder shape, and the forth row 364 is located higher than the third row 362. Thereby, the light emitting faces 346b,366b of the LED 340b,360b in the upper row are not be covered by the circuits between the two adjacent LED 340a,360a in the lower row and may front the light incident end faces 322,324 of the light guide plate 320 more effectively.

The first light incident end face 322 and the second light incident end face 324 of the light guide plate 320 are made in a ladder shape to match the first LED 340 and the second LED 360 arranged in ladder. The LED 340a of the first row 342 and the LED 360a of the third row 362 may be white LED. The second row 344 and the forth row 364 may also use red, blue and green LED besides white LED. Each the LED 340b and 360b may contain not only a single color chip inside, but also red, blue and green chips at the same time. It means the LED 340b of the second row 344 and the LED 360b of the forth row 364 may adopt white, red, blue, green LED and their combination, which can be chose in accordance with the brightness distribution.

Referring to FIG. 6, the side-emitting backlight module 300 further comprises two ladder-shaped reflectors 380a and 380b. The reflector 380a covers the first LED 340a of the first row 342 and the first LED 340b of the second row 344. The reflector 380b covers the second LED 360a of the third row 362 and the second LED 360b of the second row 364. The two ladder-shaped reflectors 380a and 380b both have two stepped parts. Those stepped parts are corresponding to the first back side 348a of the each first LED 340a in the first row 342, the second back side 348b of the each first LED 340b in the second row 344, the third back side 368a of the each first LED 360a in the third row 362, the forth back side 368b of the each first LED 360b in the forth row 364. The first back side 348a of the each first LED 340a in the first row 342 is opposite to its first light emitting face 346a, and the second back side 348b of the each first LED 340b in the second row 344 is opposite to its second light emitting face 346b. The third back side 368a of the each first LED 360a in a third row 362 is opposite to its third light emitting face 366a, and the forth back side 368b of the each first LED 360b in the forth row 364 is opposite to its forth light emitting face 366b.

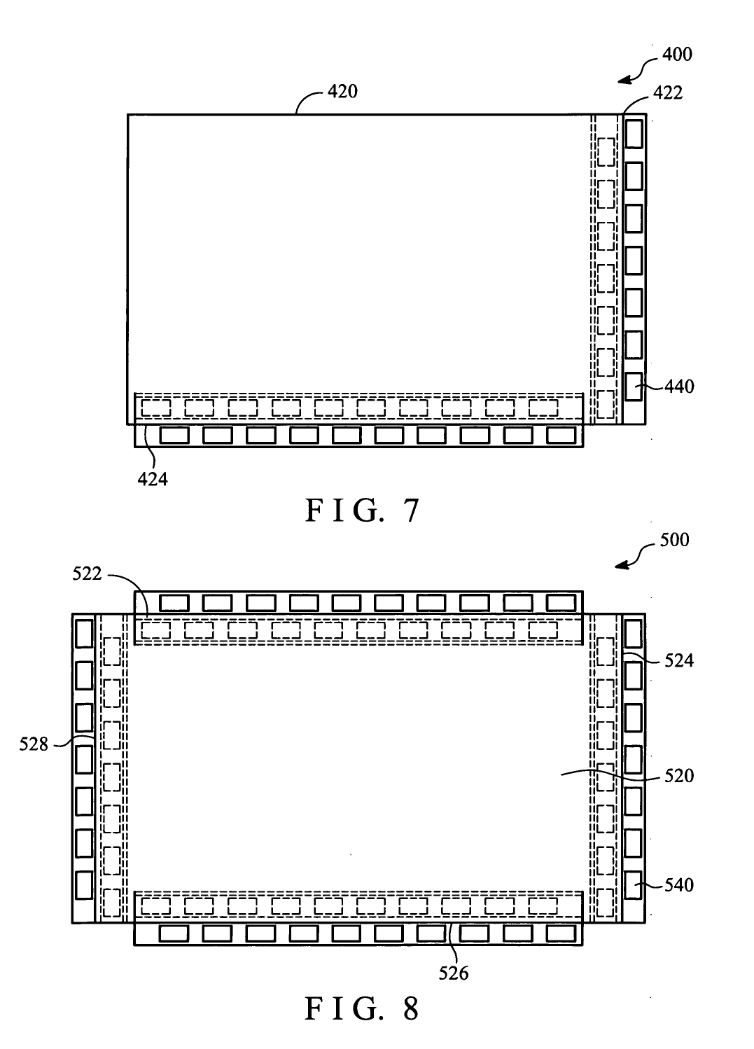

Refer to FIG. 7 for another embodiment of a side-emitting backlight module 400. The first light incident end face 422 and the second light incident end face 424 of a light guide plate 420 are disposed by the two adjacent sides of the light guide plate 420. As for any light incident end face 422,424 of the light guide plate 420, the arrangement of the LED 440 is as FIG. 2 to FIG. 4 show.

Refer to FIG. 8 for another embodiment of the side-emitting backlight module 500 according to the present invention. A light guide plate 520 has four light incident end faces 522, 524, 526, 528. As for any light incident end faces 522, 524, 526, 528 of the light guide plate 520, the arrangement of the LED 540 is as FIG. 2 to FIG. 4 show.

For all above embodiments, the side-emitting backlight module is not limited to LED, but also point light source such as laser.

According to one embodiment of the present invention, the point light sources are arranged as a plurality of rows. Each point light source of the first row is staggered with respect to each point light source of the second row, so that each light emitting face of the point light sources may front the light incident end face of the light guide plate. In this way, the point light sources become closely approximates a line light sources, which improves the spotty halo phenomena.

According to another embodiment of the present invention, the point light sources are arranged as a plurality of rows. Each point light source of the first row is staggered with respect to each point light source of the second row, the first row and the second row arranged in ladder. The light incident end face of the ladder-shaped light guide plate cooperates with a plurality of the point light sources arranged in ladder to transmit the light from the point light sources to the light guide plate. The point light sources arranged staggered and in ladder are to avoid the circuit between two adjacent point light sources in the lower row covering the light emitting face in the upper row, so that each of the light emitting faces of the point light sources may front the light incident end face of the light guide plate more efficiently.

According to another embodiment of the present invention, every point light source can be a LED. The LED far away from the light guide plate can adopt RGB chips for increasing the color field of the backlight module because of a long light-mixed distance. The ladder-shaped arrangement uses more than twice number of the LEDs than before, and increases the heat dissipation area.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A side-emitting backlight module, comprising:
a light guide plate, having a light incident end face; and
a plurality of point light sources, arranged as a first row and a second row, wherein each of the point light sources of the first row and the second row has a light emitting face, and the first row is disposed between the second row and the light guide plate, each of the point light sources of the first row is staggered with respect to each of the point light sources of the second row, so that a part of the light emitting face of each of the point light sources faces the light incident end face of the light guide plate.

2. The side-emitting backlight module of claim 1, wherein each of the point light sources comprises a light emitting diode.

3. The side-emitting backlight module of claim 2, wherein the first row and the second row are arranged in a ladder shape and the second row is located higher than the first row.

4. The side-emitting backlight module of claim 3, wherein the light incident end face of the light guide plate is in a ladder shape to match the light emitting diodes arranged in ladder.

5. The side-emitting backlight module of claim 3 further comprising a ladder-shaped reflector which has two stepped parts, respectively corresponding to a back side of each of the light emitting diodes in the first row and a back side of each of the light emitting diodes in the second row, wherein the back side of each of the light emitting diodes is opposite to the light emitting face thereof.

6. The side-emitting backlight module of claim 5 further comprising a flexible circuit board, electrically connected with the light emitting diodes and disposed between the ladder-shaped reflector and the light emitting diodes.

7. The side-emitting backlight module of claim 2, wherein all the light emitting diodes of the first row are white light emitting diodes.

8. The side-emitting backlight module of claim 7, wherein the light emitting diodes of the second row are selected from the group consisting of white, red, blue, green light emitting diodes and their combinations.

9. A side-emitting backlight module, comprising:
a light guide plate, having a first light incident end face and a second light incident end face at two sides of the light guide plate separately;
a plurality of first point light sources, arranged as a first row and a second row, wherein each of the first point light sources of the first row and the second row has a first light emitting face, and the first row is disposed between the second row and the light guide plate, each of the first point light sources of the first row is staggered with respect to each of the first point light sources of the second row, so that a part of the first light emitting face of the first point light sources faces the first light incident end face of the light guide plate;
a plurality of second point light sources, arranged as a third row and a forth row, wherein each of the second point light sources of the third row and the forth row has a second light emitting face, and the third row is disposed between the forth row and the light guide plate, each of the second point light sources of the third row is staggered with respect to each of the second point light sources of the forth row, so that a part of the second light emitting face of the second point light sources faces the second light incident end face of the light guide plate.

10. The side-emitting backlight module of claim 9, wherein each of the first point light sources and the second point light sources comprises a light emitting diode.

11. The side-emitting backlight module of claim 10, wherein the first row and the second row are arranged in a ladder shape and the second row is located higher than the first row; the third row and the forth row are arranged in a ladder shape and the forth row is located higher than the third row.

12. The side-emitting backlight module of claim 11, wherein the first light incident end face and the second light incident end face of the light guide plate are in a ladder shape respectively to match the first and second light emitting diodes arranged in ladder.

13. The side-emitting backlight module of claim 11 further comprising two ladder-shaped reflectors which each of the ladder-shaped reflectors has two stepped parts, corresponding to a back side of each of the first light emitting diodes in the first row, a back side of each of the first light emitting diodes in the second row, a back side of each of the second light emitting diodes in the third row and a back side of each of the second light emitting diodes in the forth row, wherein the back side of each of the first light emitting diodes is opposite to the first light emitting face thereof and the back side of each of the second light emitting diodes is opposite to the second light emitting face thereof.

14. The side-emitting backlight module of claim 10, wherein all the first light emitting diodes of the first row and the second light emitting diodes of the third row are white light emitting diodes.

15. The side-emitting backlight module of claim 14, wherein the first light emitting diodes of the second row and the second light emitting diodes of the forth row are selected from the group consisting of white, red, blue, green light emitting diodes and their combinations.

16. The side-emitting backlight module of claim 10, wherein the first light incident end face and the second light incident end face are at the opposite two sides of the light guide plate.

17. The side-emitting backlight module of claim 10, wherein the first light incident end face and the second light incident end face are at the adjacent two sides of the light guide plate.
